(19) United States
(12) Patent Application Publication
(10) Pub. No.: US 2020/0410573 A1
(43) Pub. Date: Dec. 31, 2020

(54) COMPUTER-IMPLEMENTED METHOD FOR GENERATING A SUGGESTION LIST AND SYSTEM FOR GENERATING AN ORDER LIST

(71) Applicant: Omikron Data Quality GmbH, Pforzheim (DE)

(72) Inventor: Carsten KRAUS, Pforzheim (DE)

(73) Assignee: Omikron Data Quality GmbH, Pforzheim (DE)

(21) Appl. No.: 16/980,967

(22) PCT Filed: Mar. 18, 2019
(86) PCT No.: PCT/EP2019/056736

§ 371 Date: Sep. 15, 2020

Related U.S. Application Data
(60) Provisional application No. 62/643,920, filed on Mar. 16, 2018.

(51) Int. Cl. G06Q 30/06

(52) U.S. Cl. CPC G06Q 30/0639; G06Q 30/0633; G06Q 30/0631

(57) ABSTRACT

A computer-implemented method for generating a suggestion list for a user for product identifications for products stored in a product database. The suggestion list is generated for a certain point in time, i.e. not only relates to the user, but also to the particular moment. Whether a product is included in this suggestion list is determined by the method by analysing the times and time intervals of past purchases of this user for this product and, if applicable, products related to this product; and also, if applicable, by corresponding times and time intervals of other purchasers. The invention also relates to a system for generating an order list and for filling a shopping basket, which system uses a device designed to carry out the method.

The present invention relates to a computer-implemented method for generating and outputting to a user a suggestion list for product identifications for products stored in a product database. Furthermore, the invention relates to a device for carrying out this method and a system for generating an order list with product identifications using such a device.

In e-commerce, a variety of products are offered by means of a website, for example via an online shop. A user who accesses the website can not only search for these products on the website and obtain information about the products, but can also purchase these products through the website. In order to make it as convenient and easy as possible for the user to search for products, user data is stored when the website is accessed. This user data is used when the website is called up again by this user in order to adapt the presentation of information and the user's search for certain products to the needs of the user in question. For example, the products last viewed, but then not purchased by the user are stored. When the user then calls up the website again, these last-viewed products are displayed on the start page to increase the probability that he will purchase these products when he calls up the website again.

It has been found that, in this way, the user can be offered products for purchase which he did not purchase when he last visited the website. However, such suggestions for purchase are not suitable in fields of application where the user has already purchased certain products and may wish to purchase these products again. In particular in fields of application where a large number of products are to be purchased on a recurring basis, there is a need to provide the user with a suggestion list which simplifies and accelerates the purchase transaction. Such fields of application are encountered, for example, in the case of online shops for food, drugstore products or pharmaceuticals; in company supply, wholesale and intermediate trade, but also in virtually all product areas. In addition to use in online shops, the method can also be used to generate shopping lists/purchase suggestions for stationary trade.

The easiest way to generate a suggestion list is to simply display all products that the user has ever purchased in this shop. However, the number of different food items purchased in a grocery store is very large. The list would therefore contain a lot of products that the user probably does not want to purchase at the present moment in time. On the other hand, it is very important for online grocery stores to be able to be able to select the appropriate food quickly. Online shopping otherwise takes a very long time. Furthermore, it turns out that people often purchase the same foods over and over again, and thus there is a need to generate a suggestion list for a repurchase of the foods.

A method for consumption-based recommendations for recurring purchases is known from U.S. Pat. No. 9,659,310 B1. This involves recommendations for automatic deliveries of certain products by subscription. With a subscription, a fixed time interval is agreed between the user and the shop. A time interval, a product quantity and the type of product are suggested for recurring purchases, based on characteristics of the pattern and purchase statistics of the user.

The present invention is based on the technical problem of specifying a computer-implemented method of the type mentioned in the introduction, which generates and outputs a suggestion list which comes as close as possible to the user's planned purchase intention. Furthermore, a system of the type mentioned in the introduction shall be described which uses a device for carrying out this method and by means of which a shopping basket can be filled with the products which the user intends to purchase.

According to the invention, this problem is solved by a computer-implemented method having the feature of claim 1 and by a system having the feature of claim 24. Advantageous embodiments and refinements will become clear from the dependent claims.

The present invention is based on the fundamental concept that the properties of a product must be taken into account. There are products which a user usually purchases only once within a certain period of time, for example several years, such as barbecue tongs. Other products, by contrast, are purchased at much shorter intervals, such as milk or toilet paper. Consequently, by looking at a user's purchase history, it is possible to predict how likely it is that this product will be purchased again. For example, it is possible to determine within what period of time a certain amount of toilet paper has been used by the user in the past. From this interval and, as applicable, the fluctuations in this interval, it can be determined whether or how likely it is that the household in question will be needing toilet paper again at the current moment in time. If this is the case, or if there is a high probability, this product is included in the suggestion list. On the one hand, the individual consumption of the user from the past can be taken into account in this case. In addition, however, a determined consumption of this product by all users can also be taken into account. Furthermore, it is possible that alternatives to a product may be suggested in the method according to the invention. Furthermore, so-called product groups can also be considered as products.

The method of the present invention uses the purchase history of a user as well as the purchase histories of other users for specific products. The method can also work if no further knowledge about the user is known. Other user data can, indeed, also be processed, such as household size or certain preferences of the user. However, this knowledge is not absolutely necessary for the method according to the invention.

In one exemplary embodiment, the purchase histories of other customers are taken into account for the second purchase of the user's most recently purchased products. From the third purchase onwards, in particular the purchase history of the user himself is taken into account. When selecting products, a function is thus applied which depends on the purchase history of the individual user and the purchase histories of other users for the product in question. The weighting, how the purchase history of the individual user on the one hand and the purchase histories of other users on the other hand are included in the function, changes with the number of purchases made.

Preferably, the function is not only aimed at individual products, but also at a product group. For example, if the user purchases a jar of jam every month, but a different flavour of this jam each time, the suggestion list will include that the purchase of a jar of jam is suggested after one month. If only the individual product were taken into account, purchases of jam of different flavours would not be taken into account.

When taking into account the purchase history of the individual user, a fluctuation range (for example standard deviation, interval quartiles/percentiles) of the purchasing rhythm can be included. The last preceding intervals can be taken into account to a greater extent than the older ones. Furthermore, the total frequency of the purchase of the product can be included.

Lastly, it can be taken into account whether a product is due for purchase, more specifically on the basis of a past time interval. If this is the case, the product is added to the suggestion list. It can also be taken into account that the product is overdue. If this is the case, the product can also be added to the suggestion list. However, if a product is more than overdue, it may be removed from the suggestion list, since it is obviously no longer relevant to the user. For example, if the user purchases barbecue charcoal or eggs every week and at some point stops purchasing them, the charcoal or eggs will be added to the suggestion list the next time the user purchases items. This is still the case for the next purchase thereafter, but not for the one after that. This takes into account that the season for this product might be over and that the user no longer wishes to purchase the product (for example due to the goal of lowering cholesterol levels, a change to a vegan diet, etc.) It can also be taken into account whether other users have purchased this product frequently at first, but then no longer. In this way, products that are no longer in demand can be identified, for example articles with football World Cup advertisements for 2018; similarly, seasonal products can be identified, for example barbecue charcoal.

The method is particularly suitable for online food retailing. However, it is also suitable for products sold by pharmacies or drugstores.

In accordance with the invention, a computer-implemented method for generating a suggestion list for a user for product identifications for products stored in a product database is proposed in which:
a. by accessing a user database assigned to the users by means of a server, a product is determined or products of the products stored in the product database are determined, which the user has purchased in the past;
b. for at least one determined product that the user has purchased in the past, the first time or the first times at which the user has purchased the product in the past is determined by access to the user database;
c. at least a first time interval from the time of a last past purchase of the product by the user to a target time is calculated by the server;
d. if multiple times have been determined at which the user has purchased the product in the past, a second time interval or second time intervals for times of successive past purchases of the product by the user is/are calculated by the server;
e. depending on the first and, if several points in time have been determined at which the user has purchased the product in the past, the second time interval or the second time intervals, a first score, which is a measure of the probability that the user will purchase the product again at the target time, is calculated by the server using a first prediction method;
f. the suggestion list for product identifications is generated on the basis of the first score.

The method according to the invention achieves the generation for the user of a suggestion list which most likely contains the products the user wishes to purchase. This is achieved in particular by considering past purchases and the corresponding time intervals of these past purchases by the user.

In particular, the target time in the method according to the invention is the time when the suggestion list is to be output or the purchases are to be made. It is therefore a prediction time. In particular, this is the current time, for example, when an online shop is called up. However, it can also be a point in the near future, for example, the time at which an electronic newsletter is sent.

The product database and the user database may also be contained in a single database in the method according to the invention, from which the corresponding data can then be retrieved.

According to one embodiment of the method according to the invention, steps b. to f. are carried out for further products stored in the product database. These steps are carried out in particular for all products which the user has purchased in the past or within a defined overall period.

According to one embodiment of the method according to the invention, the following steps are also carried out:
g. by accessing the user database, it is possible to determine, for multiple other users, at which second points in time the other users have purchased the product in the past;
h. for each of the multiple other users, a third time interval is calculated by the server, or third time intervals are calculated by the server for points in time of successive past purchases of the product by another user;
i. depending on the third time interval or the third time intervals calculated for the multiple other users, a second score, which is a measure of the probability that any user will purchase the product again at the target time, is calculated by the server using a second prediction method;
j. a function value of a function assigned to the product and the user is calculated, the variables of which include at least the first score and the second score;
k. depending on the function values assigned to the products, the suggestion list for product identifications is generated.

This ensures that a suggestion list is generated for the user, which with even greater probability contains the products that the user wishes to purchase. This is achieved in particular by considering not only past purchases and the corresponding time intervals of past purchases of the user, but also the times and the corresponding time intervals of these purchases of the products by other users.

In accordance with the invention, a relatively short suggestion list can be generated on the basis of the user's past purchases, since it is determined whether products already purchased earlier are actually also needed at present.

In comparison to the prior art, for example U.S. Pat. No. 9,659,310 B1, no fixed time interval is agreed in the method according to the invention, and instead the recommendations are dynamically adapted according to the estimated current demand; in this case a change in the behaviour of the user in question is taken into account, and seasonal dependencies can also be determined and included.

According to one embodiment of the method according to the invention, steps g. to k. are carried out for further products stored in the product database. These steps are carried out in particular for all products which the user has purchased in the past or within a defined overall period.

In accordance with one embodiment of the method according to the invention, a first weighting value is calculated depending on the second time intervals and indicates the reliability of the first score. Depending on the third time intervals, a second weighting value is calculated, which indicates the reliability of the second score. When calculating the function value, the first score is then weighted with the first weighting value and the second score with the second weighting value.

According to one embodiment of the method according to the invention, the first weighting value is zero if it was determined in step a. that the user has purchased the product only once in the past. In the case of a one-time past purchase of the product, it is not possible for the user to determine at what time intervals recurring purchases occurred in the past. In this case, however, the method takes into account the times and time intervals of other users' purchases, such that a suggestion list can be generated and output in this case as well, which probably corresponds to the user's purchase intention.

According to a development of the method according to the invention, the first weighting value is all the greater, the more frequently the user has purchased the product in the past, such that a large number of second time intervals is calculated. The function for which the function value is calculated in step j. thus weights the extent of the previous knowledge with the user. In the case that there are many known past purchases of the user, the first score in particular is taken into account and is generated on the basis of the knowledge about the customer. On the other hand, in the case that there is less knowledge about the customer's past purchases, the second score is weighted more heavily, which takes into account purchases by other users for the product in question.

In particular, the influence of the first and second scores is weighted depending on the frequency with which the user has purchased the product and, if applicable, the frequency of visits to a website or shop.

The first and/or second score are determined by means of prediction methods, in particular statistical prediction methods, which are used to estimate the future behaviour of the user.

The first score is calculated in specific embodiments, in particular using a neural network. However, it can also be calculated using other prediction methods, for example logistic regression, random forest, etc. In a specific embodiment a four-layer dense neural network is used. For the calculation of the second score a logistic regression is used in the specific embodiment. In particular a logistic regression with certain cross variables is used. It has been found that such a calculation of the first and second scores can generate particularly accurate suggestion lists. However, other methods are possible for both scores.

For example, the prediction method derives statistical values. Such values are, for example, median, standard deviation, quartiles, and minimum and maximum values. The values can be subjected to a non-linear transformation. This is done in a specific embodiment, but is not necessary for the method. These values a fed into the prediction method.

For the calculation of the first and/or the second score, various other input variables can be taken into account, which are aggregated and represent the purchasing behaviour of the user or other users over time.

For example, the median of the second time intervals can be calculated. The first score is then further calculated depending on the calculated median of the second time intervals.

Furthermore, the standard deviation of the second time intervals can be calculated alternatively or additionally. The first score is then further calculated depending on the calculated standard deviation of the second time intervals.

Furthermore, the median of the third time intervals can be calculated alternatively or additionally. The second score is then further calculated depending on the calculated median of the third time intervals if the number of the second points in time is below a threshold value. The median of the third time intervals, which takes past purchases of other users into account, is thus particularly relevant if the number of past purchases of the user is low.

Furthermore, attributes of the product and/or the user can be taken into account in the calculation of the first and/or second score.

According to one embodiment of the method according to the invention, the probability of recurring purchases of the product is determined as a first attribute of the product, for example by accessing the product database. The first and/or second score is then further calculated by the server in dependence on the first attribute. In addition, the first attribute can indicate the periodicity of the product, i.e. not only how likely recurring purchases are, but also the time intervals within which recurring purchases are likely to occur. A range can also be specified for the periodicity, i.e. the time interval of a likely recurring purchase of the product. The first attribute is stored in the product database as a product property, which generally specifies the periodicity of the product. The value of the first attribute is therefore different, for example, for barbecue tongs than for the product milk, for example.

Alternatively or additionally, the second attribute of the product can be determined as how likely a purchase of the product was at a determined time of the purchase of the product by the user or another user. The first and/or the second score is then further calculated by the server depending on the second attribute. In this way, a seasonality of the product can be determined, which takes into account the fact that the product is purchased repeatedly more often in a certain season than in another season. This can take into account, for example, that a product is purchased more often in summer and less often in winter, or vice versa. The second attribute can be determined in particular by means of a method for generating priority data for products, as described in WO 2016/174142 A1, which is included by reference in this description.

According to a development of the method, alternatively or additionally, the ratio of the first time interval to the average of the second time intervals is determined as the third attribute of the product. The first score is then calculated alternatively or additionally by the server depending on the third attribute.

According to a development of the method according to the invention, alternatively or additionally, the ratio of the first time interval to the last of the second time intervals is determined as a fourth attribute of the product. The first score is then further calculated by the server depending on the fourth attribute.

According to a development of the method according to the invention, alternatively or additionally, the time at which the product was purchased by the user or another user is determined as the fifth attribute of the product. The first and/or the second score is then further calculated by the server depending on the fifth attribute. In this way, affinities for the purchase of a product at certain times can be taken into account. Furthermore, in this case the day of the week on which the product was purchased by the user or by another user can also be taken into account.

According to a development of the method according to the invention, alternatively or additionally, it can be determined as the sixth attribute of the product whether the product was discounted when purchased by the user or another user. The first and/or the second score is then further calculated by the server depending on the sixth attribute. This takes into account that users prefer to purchase products to which a discount was applied. This is taken into account preferably when generating the first and/or second score.

According to a development of the method according to the invention, a substitution product belonging to the product is determined by accessing the product database. Steps a. to h. are then also carried out for the substitution product. Substitution products can be the products of other package sizes. They can also be identical or similar products from other suppliers. Lastly, products with a different taste or smell or a different dosage form, especially in the case of pharmaceuticals, may be taken into account. Furthermore, substitution products may be products belonging to the same type of product, such as another cheese, or products that meet the same need, such as cheese instead of sausage.

Additionally or alternatively to the purchase of a product, it may be taken into account that the user or another user has accessed information about the product via a network. For example, it can be taken into account if the user or another user has called up the product in an online shop and, if applicable, also placed it in an electronic shopping basket, but has not purchased this product, or has purchased another product instead.

In the method according to the invention, a product identification, a user identification and/or a time of purchase are stored in the user database to generate the user database when a product is purchased. In addition, the number of purchased units of the product and the price at the time of purchase of the product can be stored.

According to one embodiment of the method according to the invention, when a product is purchased, the product identification of the product is captured by means of a first sensor, and the user identification by means of a second sensor. The captured product identification and user identification are then stored in the user database. The first sensor can, for example, be a scanner for a code, such as a barcode, which is connected to the server via an electronic checkout. The second sensor can, for example, capture features of the user. For example, biometric features of the user can be automatically captured. Furthermore, the user can enter the user identification code directly into the sensor, or the user identification can be obtained when paying for the product, for example by using credit card data or the like as user identification.

Customers purchase toothpaste, sugar or orange juice again and again. In the case of these products, shopping is not an experience, but an annoying chore. The invention makes this chore easier, especially through artificial intelligence. The special feature of the method according to the invention is, among other things, that the suggestion list is generated for a certain point/period in time, i.e. not only relates to the user, but also to the particular moment. Whether a product is included in the suggestion list is determined by the method by analysing the times and time intervals of past purchases of this user for this product and, if applicable, products related to this product; and also, if applicable, by corresponding times and time intervals of other purchasers. The method may also take into account, but is not dependent on, other variables such as weather. The method determines the suggestion list according to different criteria depending on the frequency of the user's previous visits and the frequency with which he/she has already purchased the product in question. The less frequently, the more the purchases of other customers are taken into account; the more frequently, the more the purchases of the specific user are taken into account.

In one of the sub-methods, the probability that a product will be purchased repeatedly at all is calculated. In addition, the time interval and, if applicable, its fluctuation margin is determined both across all users and across all time periods. From these three variables, a prediction method (regression, random forest, neural network, etc.) is used to derive the user-independent prediction. In the second sub-method, a user-specific first score for the product in question is derived from the user-specific points in time, the intervals resulting from them, and their fluctuation probabilities. In the third sub-method, the seasonal dependence of the product is determined. In the collective method, the suggestion list results from the combination of the three methods. For this purpose, a prediction method takes into account the values of the sub-methods, the frequency of the purchase of this product by the user, and, if applicable, the overall frequency of the visit, for example to the online shop by this user. If applicable further variables can be included in the method. The function values are used to generate a suggestion list that contains a number of product identifications.

The method can also be used to determine when to send the user the order suggestion list.

The invention further relates to a device for data processing comprising a processor configured to perform the method described above.

The invention also relates to a system for generating an order list with product identifications. The system comprises the above-mentioned data processing device. The system further comprises an input interface for detecting a user input for accepting or modifying the suggestion list output by the device and for generating an order list with product identifications. In particular, the input interface is designed in such a way that if the suggestion list is accepted, the order list will contain the same product identifications as the suggestion list. If the suggestion list is changed by a user input, the order list contains the correspondingly changed list with product identifications.

According to a development of the system according to the invention, said system further comprises a control unit which is coupled to the input interface and which is designed to determine and output to the user, by accessing the product database, position data of the product identifications in the order list.

According to a development of the system according to the invention, it lastly comprises a filling device for filling the shopping basket with products to which the product identifications in the order list are assigned.

According to a development of the system according to the invention, it further comprises a control unit which is coupled to the input interface and the filling device and which is designed to transmit position data of the product identifications in the order list to the filling device by accessing the product database. In this case, the filling device is designed to transport the products of the product identifications in the order list from positions corresponding to the position data transmitted by the control unit to the shopping basket.

The control unit can also be coupled to the filling device. It can then be designed to transmit the position data of the product identifications in the order list to the filling device. The filling device can then be designed to transport the products of the product identifications in the order list from positions that correspond to the position data transmitted by the control unit to the shopping basket.

With the system according to the invention, the user can be supported in filling a shopping basket. The selection is accelerated and facilitated by the generation of the suggestion list, and the filling of the shopping basket is supported by the automated filling device, which is controlled by the control unit.

Lastly, the invention relates to a computer program product comprising instructions which, when executed by a computer, cause the computer to carry out the method described above.

The invention will now be explained on the basis of embodiments with reference to the drawings.

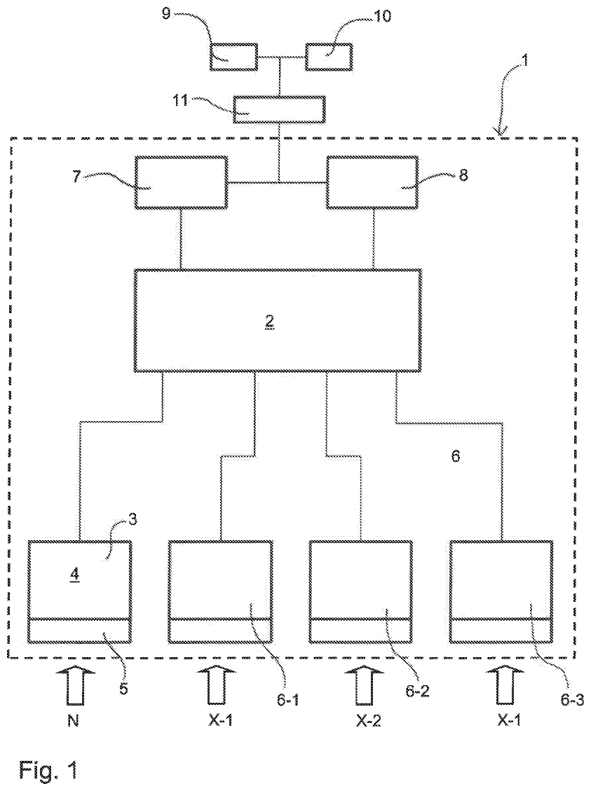

FIG. 1 schematically shows the structure of an embodiment of the device according to the invention;

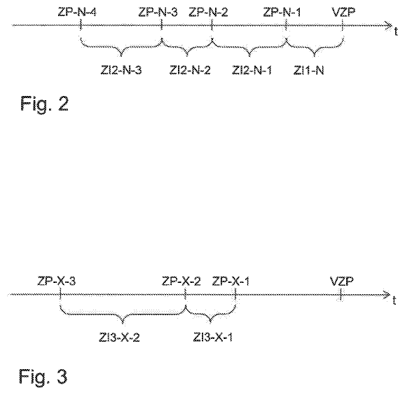

FIG. 2 shows a chronological depiction of purchases made by the user in the past;

FIG. 3 shows a chronological depiction of purchases by other users in the past;

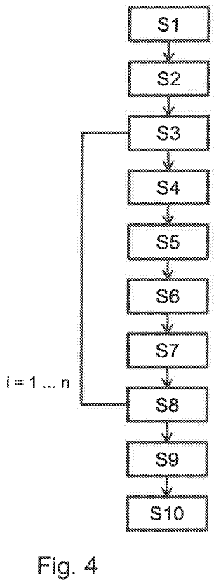

FIG. 4 shows a flowchart of an embodiment of the method according to the invention; and

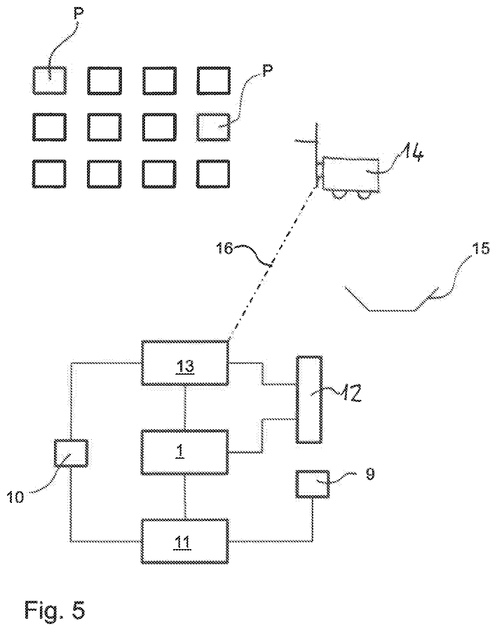

FIG. 5 shows schematically the structure of an embodiment of the system according to the invention.

With reference to FIG. 1, the structure of the embodiment of the device 1 according to the invention is explained first.

The device 1 comprises a server 2, which for example provides an online shop for food. A client 3 of a user N is connected to the server 2 in a manner known per se, for example via the Internet. The client 3 comprises an output unit 4, for example a display, and an input unit 5, for example a keyboard and an electronic mouse. The output unit 4 could alternatively be provided via a mobile device or other interfaces, such as a television or other devices. In addition, clients, generally denoted by 6, of other users, generally denoted by X, can be coupled to the server 2 via the Internet. FIG. 1 shows an example of three clients 6-1, 6-2 and 6-3 of other users X1, X2 and X3. Clients 3 and 6 can call up websites from the server 2 and use these websites to purchase a variety of products P.

To provide the online shop, the server 2 is coupled to a product database 7 and a user database 8. The user database 8 stores data regarding past purchases by users of the online shop provided by server 2. The product database 7 stores data regarding the products offered in the online shop.

During the operation of the online shop, the server stores data regarding user interactions in the user database 8 For example, data is stored when a certain user N places a product P in an electronic shopping basket. Data are also stored when the user N or another user X purchases a product P via the online shop.

In addition, the server 2 stores in the product database 7, for the individual products P, product identifications, properties and attributes of the products P as well as any other data belonging to the products P, as will be explained later.

Optionally, the device 1 can also detect purchases in shops. For this purpose, it can have an interface to a detection unit 11, for example, an electronic checkout. The detection unit 11 is coupled to a first sensor 9 and a second sensor 10. The first sensor 9 can detect a user identification when purchasing a product P, and the second sensor 10 can detect a product identification of a purchased product P. These data can be stored in the product database 7 and the user database 8 by means of the detection unit 11, such that server 2 can also access such purchases in shops.

With reference to FIGS. 2 and 3, it is explained how the time sequence of past purchases by the user N and other users X are recorded.

In FIGS. 2 and 3, ZP generally denotes a point in time, the addition N an assignment to the user N, the addition X an assignment to another user X, and a number as an addition of a numbering. ZI denotes a time interval, wherein the corresponding additions are also used in this case. VZP denotes a prediction time or a target time at which the method outputs the suggestion list.

In FIG. 2, for example, the case is shown where the user N has purchased a certain product P in the past before the target time VZP at the time ZP-N-1. The time interval between the target time VZP and the time ZP-N-1 of the last purchase of the product P by the user N is denoted by ZI1-N. The time interval ZI1-N is referred to as the first time interval. Furthermore, in the case shown in FIG. 2, the user N has purchased the product P at further times ZP-N-2, ZP-N-3, ZP-N-4. This results in the second time intervals ZI2-N-1, ZI2-N-2 and ZI2-N-3.

Data regarding the purchases of the product by the user N are stored in the user database 8 by means of the server 2 or the detection unit 11. In particular, the following data are stored for each purchase: the time of purchase including the time and date, a user identification, which is preferably pseudonymised, and a product identification, for example an article number of the product P. Furthermore, the number of purchased products P and the corresponding price can be stored in the user database 8.

In the same way, purchases of other users X are also stored in the user database 8 during the operation of the online shop. This is explained with reference to FIG. 3.

Another user X purchased the product P in question at the times ZP-X-1, ZP-X-2 and ZP-X-3, and therefore, between two consecutive times of these purchases, the time intervals ZI3-X-1 and ZI3-X-2 result. These time intervals are also referred to as third time intervals. The data regarding these purchases are also stored user-specifically in the user database 8.

In the following, an exemplary embodiment of the method according to the invention is explained with reference to FIG. 4, while at the same time further embodiments of the device 1 according to the invention will be described.

The starting point of the method is that in the user database 8 the past purchases of a product P of a user N are stored together with the related data described above. In the same way, for a large number of other users X, corresponding data of past purchases are stored in the user database 8. Furthermore, properties and attributes of the product P are stored in the product database 7.

In step S1, the user N calls up a website of the online shop operated by the server 2 using the client 3, and the user N logs in so that he is detected by the server 2 via a user identification.

In a step S2, the server 2 then determines which products P the user N has purchased in the past by accessing the user database 8. For this purpose, a certain overall time period for past purchases can be used. For example, past purchases of the user N within the last 14 months can be viewed. For example, the customer has purchased products P1 to Pn in the past. The following steps are now performed for each of these products P1 to Pn.

In a step S3, it is determined for the product Pi by accessing the user database 8 by means of server 2 at which first time ZP-N-1 or at which times ZP-N-j (j>0) the user N purchased the product Pi in the past.

In a step S4, the server 2 calculates the time intervals between the times of the purchases. Since a time ZP-N-1 is always available for a past purchase by the user N, the first time interval ZI1-N is calculated by the server 2. If additional times ZP-N-j have been determined at which the user N purchased the product Pi in the past, the server will calculate a second time interval ZI2-N-1 or second time intervals ZI2-N-j for times of successive past purchases of the product Pi by the user N.

Then, in a step S5, the server 2 calculates a first score, which is a measure of the probability that the user N will purchase the product Pi again at the target time VZP, depending on the first time interval ZI1-N and, if multiple times have been determined at which the user N purchased the product Pi in the past, the second time interval ZI2-N-1 or the second time intervals ZI2-N-j. A first weighting value is also determined. The first weighting value provides a measure of the reliability of the first score for the probability that, taking into account the past purchases of user N, this user will want to purchase the product Pi again.

For this purpose, the temporal input variables described above are aggregated for a neural network. The aggregated input variables characterise the developments of the purchasing behaviour of the user N for the product Pi over a certain time period. In the present embodiment, a four-layer dense neural network with 2.4 million synapses is used for this purpose. It has been found that a reduction in the number of synapses or layers leads to poorer results, but an increase does not lead to an improvement. The neural network thus outputs the first score and, as applicable, also the first weighting value.

It has been found that the calculation of the first or second score on the basis of dense neural networks or logistic regressions has advantages over the calculation by other methods of artificial intelligence which are based on the pure purchase streams, i.e. the individual purchase transactions, without aggregation of the input variables. For this purpose, an application of artificial intelligence with recurrent neural networks could be implemented, for example, in which, for example, long term short term memory (LSTM) is used. However, the computing effort in this case is very high. The methods specified for the method according to the invention require much less computing power, and therefore the suggestion list can be generated so quickly that it can be used in an online shop without the user N leaving the online shop before the suggestion list is output.

Another possibility would be an approach with neural networks with less computing effort, for example based on one-dimensional convolutional neural networks. In this case, however, the computing effort is also much greater than with the aggregated input variables as described in conjunction with the method according to the invention.

In step S6, by accessing the user database 8 for a large number of other users X, it is determined at which second times ZP-X-j (jA) the other users X purchased the product Pi in the past. From this, the server 2 calculates, for another user X, a third time interval ZI3-X-1 or third time intervals ZI3-X-j for points in time of successive past purchases of the product Pi by another user X.

In step S7, the server 2 calculates a second score and a second weighting value depending on the third time interval ZI3-X-1 or the third time intervals ZI3-X-j, which were calculated for the multiple other users X. In this embodiment a logistic regression with certain cross variables is used for this purpose. Alternatively, a neural network could also be used in this case. The second score, which is generated by the logistic regression, is a measure of the probability that any user will purchase the product again at the target time VCP. The calculated second weighting value also indicates how reliable the second score is.

In a step S8, a function value assigned to the product Pi of a function for which the variables comprise the first score and/or the second score is calculated, the first score being weighted with the first weighting value and the second score being weighted with the second weighting value. The weighting ensures that the more meaningful the particular score is, the greater the extent to which it is included in the function value.

If, in the present exemplary embodiment, it is determined that user N has purchased the product Pi only once in the past, i.e. only at the time ZP-N-1, and the first time interval ZI1-N is present, the first weighting value is set to zero, so that the first score in this case is not considered in the calculation of the function value. The function value is then only calculated on the basis of the second score, which was generated on the basis of past purchases by other users X.

If several past purchases by the user N have been determined for the product Pi, the first weighting value is greater than zero. In particular, the more frequently the user N has purchased the product Pi in the past, especially within the overall time period, the greater the weighting value. In this case, in particular a large number of second time intervals ZI2-N-j can be calculated. In the calculation of the function value, the second score, which was obtained on the basis of purchases by other users X, is then taken into account to a lesser extent. For example, the function value is all the higher, the more likely it is that the corresponding product P will be purchased again by the user at the target time VZP.

On the other hand, it is also possible that past purchases of other user X are not taken into account, such that the second weighting value is set to zero. Only past purchases by the user N are then taken into account in the method.

From step S8, the method returns to step S3, and steps S3 to S8 are performed for the next product Pj that user N has already purchased at least once in the past, until these steps have been performed for all products P1 to Pn. Thus, a certain function value is then available for each product.

In step S9, a suggestion list is then generated depending on the function values assigned to the products P and contains product identifications. The suggestion list can, for example, contain product identifications of products P whose function value exceeds a certain threshold value. Alternatively, a certain number of product identifications of products P whose function values are the highest can be included in the suggestion list.

In step S10, the suggestion list with the product identifications is then output to the user N via the output unit 4. Alternatively or additionally, it can be output via an output unit to another apparatus for further processing.

In the following, supplementations to the previously described exemplary embodiment of the method according to the invention which lead to further embodiments are described.

Alternatively or additionally, in step S5, the number of purchases of a product Pi by the user N within the overall time period may be considered as an aggregated input variable.

Alternatively or additionally, in step S5, the median or a certain percentile of the second time intervals ZI2-N-j of the times of purchases of the product Pi by the customer N can be taken into account as an aggregated input variable in the calculation of the first score.

Alternatively or additionally, the standard deviation of the second time intervals ZI2-N-j for the product Pi for past purchases by the user N can also be taken into account in the calculation of the first score in step S5.

Alternatively or additionally, the last detected second time interval ZI2-N-1 for the product Pi for past purchases by the user N may also be considered as an aggregated input variable in step S5.

Alternatively, the individual times and intervals can be taken into account to varying degrees when determining the statistical variables, with newer times/intervals being taken into account to a greater extent.

Alternatively or additionally, each time and each interval can be included individually as input variables in the prediction function. For the individual times, additional properties such as the day of the week or time of day, as well as additional data determined, such as the weather at that time, can be included.

Alternatively or additionally, the probability of recurrent purchases of the product P can be determined as an aggregated input variable as a first attribute of the product P by accessing the product database 7. This first attribute may be stored in the product database 7 independently of any past purchases by the user N or other users X. It reflects a property of the product itself. This first attribute can be taken into account in step S5 and/or in step S7 when calculating the first and second scores.

Furthermore, alternatively or additionally, as a second attribute of the product P, it can be determined how likely was a purchase of the product P by the user N at a determined time ZP-N-j. In addition, it could be determined, as a second attribute of the product P, how likely was a purchase of the product P at a determined time ZP-X-j of the purchase of the product P by another user X. The second attribute can then be taken into account in step S5 and/or in step S7 when calculating the first or second score. In this way, a seasonality intensity of a product P across all customers at the time of the previous purchase of this product P by the user N or by another user X is taken into account. In addition, the seasonality intensity of a product P across all other users X at the target time VZP can be taken into account.

The seasonal intensity can be determined, for example, by means of the method for generating priority data for products, as described in WO 2016/174142 A1, which is included by reference in the description.

Alternatively or additionally, a third attribute can be taken into account in step S5 when calculating the first score and is the ratio of the first time interval ZI1-N to the average of the second time intervals ZI2-N-j. In this way, the duration since the last purchase of the product P by the user N is taken into account in relation to typical time intervals between purchases of this product P by this user N.

Alternatively or additionally, the ratio of the first time interval ZI1-N to the last ZI2-N-1 of the second time intervals ZI2-N-j can be determined as the fourth attribute of the product P and taken into account as an aggregated input variable in step S5 when calculating the first score. In this way, the length of time between the target time VZP and the last purchase of this product P by the user N is taken into account in relation to the last determined second time interval.

The calculation of the function value for a product P for the suggestion list, for relatively new users N or for new combinations of the user N with a certain product P, cannot yet be derived accurately from the past purchases of this user N. If a user N has very rarely purchased a certain product P, it is difficult to predict whether he will purchase it again when he re-visits the online shop. In this case, as described above, the probability of the product demand is predicted completely or for the most part on the basis of the general repeat purchase characteristics of the product P on the basis of past purchases by all other users X. For the calculation of the second score in step S7, in this case the following aggregated input variables in particular can be considered alternatively or additionally.

The median of the third time intervals ZI3-X-j and the second score can be calculated furthermore depending on this median. This aggregated input variable is then used in particular if the number of first time points, ZP-N-j, i.e. the number of past purchases by the user N, is below a threshold value.

Furthermore, a so-called AC score can be considered alternatively or additionally. This indicates a general relative probability of repeat purchases for the products P, which is based on the considerations of Agresti & Coull for approximating the binomial distribution, although no binomial distribution is calculated here.

In yet a further exemplary embodiment of the method according to the invention, the iteration of steps S3 to S8 not only takes into account the quantity of the products Pi which the user N has already purchased in the past. In addition, this iteration is carried out for substitution products for the products Pi. For this purpose, a substitution product belonging to a product Pi is determined by accessing the product database 7. Steps S2 to S8 are then carried out for this substitution product, and then steps S9 and S10 are carried out, taking the scores for this substitution product into account.

In a further exemplary embodiment, not only past purchases of a product P by the user N or another user X are taken into account, but additionally also visits by the user N or other user X where a product P of the product database 7, or a product group containing a product P of the product database 7, was not purchased. For example, the method may additionally take into account that the user N or another user X has only accessed information about a product P in the online shop, but has not purchased the product P.

In a further exemplary embodiment, the time and, if applicable, the day of the week on which the product P was purchased by the user N or another user X is determined as the fifth attribute of the product P. The first and/or second score is then calculated in step S5 or in step S7 depending on this fifth attribute.

It can also be taken into account if the product P was purchased at a time when it was subject to a discount. Furthermore, it can be taken into account that the product P, when it was purchased, was the cheapest product in a substitution group at a certain point in time. The influence of these factors can be taken into account both in the calculation of the first score and in the calculation of the second score.

Lastly, it could also be determined how the fidelity ratio was of a user N or another user X to a particular product relative to substitutes, and this could be taken into account as a further aggregated input variable in the calculation of the first and/or second score.

With reference to FIG. 5, an exemplary embodiment will be described hereinafter of the system according to the invention for generating an order list with product identifications for filling a shopping basket 15, which order list in the embodiment is also designed for filling a shopping basket 15.

The system comprises the device 1 described with reference to FIG. 1 and with reference to the embodiment of the method according to the invention. As already explained with reference to FIG. 1, the device 1 is coupled to a detection unit 11, which in the embodiment of the system is designed as an electronic checkout 11. The electronic checkout 11 is connected to the first sensor 9 and the second sensor 10.

The system is used generally to record purchases by the user N and other users X. During a payment process, the second sensor 10, which can be designed as a scanner for a product code, for example, records product identifications of the purchased products and transmits them to the electronic checkout 11. During the subsequent payment process, the user N or another user X is identified by means of the first sensor 9, for example by means of an identification of an electronic payment card. The electronic cash register 11 stores this data in the user database 8, as explained above. In this way, a purchase by the user N or another user X can be recorded and stored by means of the system in a shop.

In addition, the system is designed in accordance with the invention to generate an order list. For this purpose, the user N is first identified by means of the first sensor 9. The user identification of the user N is transmitted from the electronic checkout 11 to the device 1. As explained above, the device 1 then generates a suggestion list for the user N for those products P which the user N has already purchased in the past. The product identifications of the products in the suggestion list are output by means of a touch screen 12, which is controlled by the device 1. The user N can accept the suggestion list via the touch screen 12 or change it by user inputs. For example, the user N can select additional products P on the touch screen 12, which he has not yet purchased. The touchscreen 12 thus represents an input interface for detecting a user input, in particular for accepting or for changing the suggestion list output by the device 1.

When the user completes the input on the touch screen 12, an order list with product identifications is generated.

In addition, the system of this embodiment is designed to output position data of the product identifications in the order list.

The order list is transmitted from the touch screen 12 and to a control unit 13. The control unit accesses the product database 7 of the device 1, loads the position data of the product identifications in the order list and transmits this position data to the user. For example, the position data can be displayed by the touch screen 12. Preferably, however, the position data are transmitted wirelessly to a mobile device of the user.

Furthermore, the system of this embodiment is designed to fill a shopping basket 15.

The order list is also in this case transmitted from the touch screen 12 and to the control unit 13. The control unit 13 is additionally coupled to the device 1 and to the second sensor 10. The control unit 13 transmits the product identifications in the order list to the second sensor 10, which forwards it on to the electronic checkout 11. Together with the user identification transmitted by the first sensor 9, the electronic checkout 11 stores this data in the user database 8, so that these purchases can be used again in subsequent purchase transactions.

The system also comprises a filling device 14 for filling a shopping basket 15 with products P, to which the product identifications in the order list are assigned. A wireless communication link 16 exists between the control unit 13 and the filling device 14. The control unit accesses the product database 7 of the device 1, loads the position data of the product identifications in the order list and transmits these position data to the filling device 14. The filling device 14 is a mobile unit by means of which products P, for example from shelves at certain positions, can be taken and placed in the shopping basket 15. The filling device 14 receives from the control unit 13 via the wireless communication connection 16 the order list with the corresponding position data of the products in the order list. The filling device 14 then moves to the corresponding positions of the products in the order list and transports these products P to the shopping basket 15. If the shopping basket 15 is completely filled with the products in the order list, the filling device 14 communicates this to the control unit 13, which transmits a corresponding signal to the electronic checkout 11. The electronic checkout 11 can then automatically trigger the payment process for the user N, for example via the Internet. The user N can take the products P from the shopping basket 15.

### LIST OF REFERENCE SKINS

1 device
2 server
3 client of the user
4 output unit
5 input unit
6 clients of the other users
6-1 client of another user
6-2 client of another user
6-3 client of another user
7 product database
8 user database
9 first sensor
10 second sensor
11 detection unit; electronic checkout
12 touch screen
13 control unit
14 filling device
15 shopping basket
16 wireless communication link

1. A computer-implemented method for generating a suggestion list for a user for product identifications for products stored in a product database, said method comprising:
a. by accessing a user database assigned to the users by means of a server, a product is determined or products of the products stored in the product database are determined, which the user has purchased in the past;
b. for at least one determined product that the user has purchased in the past, the first time or the first times at which the user has purchased the product in the past is determined by access to the user database;
c. at least a first time interval from the time of a last past purchase of the product by the user to a target time is calculated by the server;
d. if multiple times have been determined at which the user has purchased the product in the past, a second time interval or second time intervals for times of successive past purchases of the product by the user is/are calculated by the server;
e. depending on the first and, if several points in time have been determined at which the user has purchased the product in the past, the second time interval or the second time intervals, a first score, which is a measure of the probability that the user will purchase the product again at the target time, is calculated by the server using a first prediction method; and
f. the suggestion list for product identifications is generated on the basis of the first score.

2. (canceled)

3. The method according to claim 1, wherein the method further comprises the following steps:
g. by accessing the user database, it is determined, for multiple other users, at which second points in time the other users have purchased the product in the past;
h. for each of the multiple other users, a third time interval is calculated by the server, or third time intervals are calculated by the server for points in time of successive past purchases of the product by another user;
i. depending on the third time interval or the third time intervals calculated for the multiple other users, a second score, which is a measure of the probability that any user will purchase the product again at the target time, is calculated by the server using a second prediction method;
j. a function value of a function assigned to the product and the user is calculated, the variables of which include at least the first score and the second score; and
k. depending on the function values assigned to the products, the suggestion list for product identifications is generated.

4. (canceled)

5. The method according to claim 3, wherein:
a first weighting value is calculated depending on the second time intervals and indicates the reliability of the first score,
depending on the third time intervals, a second weighting value is calculated, which indicates the reliability of the second score, and
when calculating the function value, the first score is then weighted with the first weighting value and the second score with the second weighting value.

6. The method according to claim 5, wherein:
the first weighting value is zero if it has been determined in step a. that the user has purchased the product only once in the past.

7. The method according to claim 5, wherein:
the first weighting value is all the greater, the more frequently the user has purchased the product in the past, such that a large number of second time intervals are calculated.

8. The method according to claim 3, wherein:
the first score is calculated by means of a neural network and/or the second score is calculated by means of a logistic regression.

9. (canceled)

10. The method according to claim 1, wherein:
the median of the second time intervals is calculated and the first score is further calculated depending on the calculated median of the second time intervals.

11. The method according to claim 1, wherein:
the standard deviation of the second time intervals is calculated and the first score is further calculated depending on the calculated standard deviation of the second time intervals.

12. The method according to claim 3, wherein:
the median of the third time intervals is calculated and the second score is further calculated depending on the calculated median of the third time intervals if the number of the second points in time is below a threshold value.

13. The method according claim 3, wherein:
the probability of recurring purchases of the product is determined as a first attribute of the product by accessing the product database, and
the first score and/or the second score is further calculated by the server in dependence on the first attribute.

14. The method claim 3, wherein:
a second attribute of the product is determined as how likely a purchase of the product was at a determined time of the purchase of the product by the user or another user, and
the first score and/or the second score is then further calculated by the server depending on the second attribute.

15. The method according claim 1, wherein:
the ratio of the first time interval to the average of the second time intervals is determined as a third attribute of the product, and the first score is further calculated by the server depending on the third attribute;
and/or
the ratio of the first time interval to the last of the second time intervals is determined as a fourth attribute of the product, and the first score is further calculated by the server depending on the fourth attribute;
and/or
the time at which the product was purchased by the user or another user is determined as a fifth attribute of the product, and the first score and/or the second score is then further calculated by the server depending on the fifth attribute;
and/or
it is determined as a sixth attribute of the product whether the product was discounted when purchased by the user or another user, and the first score and/or the second score is further calculated by the server depending on the sixth attribute.

16-18. (canceled)

19. The method according to claim 1, wherein:
a substitution product belonging to the product is determined by accessing the product database, and
steps a. to h. are also carried out for the substitution product.

20-21. (canceled)

22. A method according to claim 1, wherein:
when a product is purchased, a product identification of the product is captured by means of a first sensor, and a user identification by means of a second sensor, and
the captured product identification and user identification are stored in the user database.

23. A device for data processing comprising a processor configured such that it performs the method according to claim 1.

24. A system for generating an order list with product identifications, said system comprising:
a data processing device according to claim 23 and
an input interface for detecting a user input for accepting and/or modifying the suggestion list generated by the device and for generating an order list with product identifications.

25. The system according to claim 24, wherein the system further comprises:
a control unit which is coupled to the input interface and which is designed to determine and output to the user, by accessing the product database, position data of the product identifications in the order list.

26. The system according to claim 24, wherein the system further comprises:
a filling device for filling a shopping basket with products to which the product identifications in the order list are assigned.

27. The system according to claim 26, wherein
the control unit is coupled to the filling device,
the control unit is designed to transmit the position data of the product identifications in the order list to the filling device, and
the filling device is designed to transport the products of the product identifications in the order list from positions corresponding to the position data transmitted by the control unit to the shopping basket.

28. A computer program product comprising instructions which, when the program is executed by a computer, cause the computer to carry out the method according claim 1.
